(19) United States
(12) Patent Application Publication
(10) Pub. No.: US 2025/0103636 A1
(43) Pub. Date: Mar. 27, 2025

(54) GENERATING AND PROVIDING AGGREGATED FEED INTERFACES SUMMARIZING THREAD DATA ACROSS MULTIPLE DATA FEEDS

(71) Applicant: Dropbox, Inc., San Francisco, CA (US)

(72) Inventors: Richard Chan, San Francisco, CA (US); Devin Mancuso, San Francisco, CA (US); Sateesh Srinivasan, Redwood City, CA (US); Yidi Zhang, San Jose, CA (US)

(21) Appl. No.: 18/474,878

(22) Filed: Sep. 26, 2023

(51) Int. Cl. G06F 16/34; G06F 16/335; G06F 16/338

(52) U.S. Cl. CPC G06F 16/345; G06F 16/335; G06F 16/338

(57) ABSTRACT

The present disclosure is directed toward systems, methods, and non-transitory computer readable media for generating and providing an aggregated feed interface that includes or presents aggregate summaries for thread data across multiple data feeds of a user account. In some embodiments, the disclosed systems generate an aggregate summary by extracting digital communications and other thread data from a variety of data feeds across multiple computer applications and by utilizing a summary generation model to generate an aggregate summary that combines and condenses the thread data from the different data feeds. For example, the disclosed systems determine topics associated with thread data from various data feeds and generates different aggregate summaries for different topics. The disclosed systems can further rank aggregate summaries and/or other digital communications to present within the aggregated feed interface according to an account-specific ranking algorithm resulting a customized per-account presentation of the aggregated feed interface.

### BACKGROUND

Advancements in computing devices and networking technology have given rise to a variety of innovations in cloud-based digital content storage and access. For example, online digital content systems can provide access to, and synchronize changes for, digital content items across devices all over the world. Existing systems can also facilitate digital communications worldwide, using networks to transmit data for emails, text messages, and other messaging formats and applications. Indeed, modern online digital content systems can provide access to, and communicate about, digital content for user accounts to collaborate across diverse physical locations and over a variety of computing devices. Despite these advances, however, existing digital content systems continue to suffer from a number of disadvantages, particularly in terms of flexibility and efficiency.

As just suggested, some existing digital communication systems are inflexible. In particular, many existing systems are rigidly fixed to a single platform or messaging protocol. For example, some existing systems generate and provide emails while other existing systems generate and provide text messages using short message service (SMS) or a different instant messaging protocol. In each of these different prior systems, digital communications are generated and transmitted over computer networks according to a single, specific messaging protocol, and digital communications of different formats or protocols are not transmissible using network infrastructures designed for other (often incompatible) formats or protocols. For instance, SMS systems cannot generate or transmit emails.

Due at least in part to their inflexibility, many existing digital content systems are also inefficient. To elaborate, many existing systems provide inefficient user interfaces that require excessive numbers of user interactions to access desired data and/or functionality. For example, some existing systems require constant navigation between different interfaces and applications to access and/or generate different types of digital communications, including emails, social media posts, text messages, or other instant messages. Indeed, to generate or access an email, existing systems generally require using an email-specific computer application, while generating or accessing a text message requires an entirely separate, text-message-specific computer application. As the number of channels (e.g., types of digital communication) increases for a user account, so too does the number applications and interfaces required to generate, access, and transmit the digital communications on a channel-by-channel basis. Not only is navigating across the increasing number of interfaces of such single-channel or single-purpose applications navigationally inefficient, but opening, closing, and running the multiple applications is computationally inefficient as well, consuming excessive amounts of computer resources that could otherwise be preserved with more efficient systems.

Thus, there are several disadvantages with regard to existing digital content systems.

### SUMMARY

This disclosure describes one or more embodiments of systems, methods, and non-transitory computer readable storage media that provide benefits and/or solve one or more of the foregoing and other problems in the art. For instance, the disclosed systems generate and provide an aggregated feed interface that includes or presents aggregate summaries for thread data (e.g., digital communications and/or contextual activity data) across multiple data feeds of a user account. In some embodiments, the disclosed systems generate an aggregate summary by extracting digital communications and other thread data from a variety of data feeds (e.g., digital communication threads, debugging ticket feeds, social media posts, and/or project collaboration trackers) across multiple computer applications and by utilizing a summary generation model (e.g., a large language model) to generate an aggregate summary that combines and condenses the thread data from the different data feeds. For example, the disclosed systems determine topics associated with thread data from various data feeds and generates different aggregate summaries for different topics. The disclosed systems can further rank aggregate summaries and/or other digital communications to present within the aggregated feed interface according to an account-specific ranking algorithm resulting a customized per-account presentation of the aggregated feed interface.

### BRIEF DESCRIPTION OF THE DRAWINGS

This disclosure will describe one or more example implementations of the systems and methods with additional specificity and detail by referencing the accompanying figures. The following paragraphs briefly describe those figures.

FIG. 1 illustrates a schematic diagram of an example environment of an aggregated interface system in accordance with one or more embodiments.

FIG. 2 illustrates an example overview of generating and providing aggregate summaries within an aggregated feed interface in accordance with one or more embodiments.

FIG. 3 illustrates an example diagram for extracting topics and performing downstream processes in accordance with one or more embodiments.

FIG. 4 illustrates an example diagram for ranking content items for an aggregated feed interface in accordance with one or more embodiments.

FIG. 5 illustrates an example aggregated feed interface in accordance with one or more embodiments.

FIG. 6 illustrates an example aggregated feed interface in accordance with one or more embodiments.

FIG. 7 illustrates an example flowchart of a series of acts for generating and providing aggregate summaries within an aggregated feed interface in accordance with one or more embodiments.

FIG. 8 illustrates a block diagram of an exemplary computing device in accordance with one or more embodiments.

FIG. 9 illustrates an example environment of a networking system having the aggregated interface system in accordance with one or more embodiments.

### DETAILED DESCRIPTION

This disclosure describes one or more embodiments of an aggregated interface system that can generate, provide, and modify an aggregated feed interface that includes or presents aggregate summaries for thread data across multiple data feeds of a user account. To elaborate, the aggregated interface system can generate an aggregated feed interface that condenses and consolidates digital communications and contextual activity data across various computer applications into a single, efficient interface. In many scenarios, either professionally or personally, user accounts are linked to many different computer applications, including applications dedicated to digital communication of one form or another as well as applications designed for tracking project collaboration, social media posting, and/or updating debugging tickets. As described herein, the aggregated interface system can generate an aggregated feed interface that efficiently centralizes information from the various applications linked to the user account. As part of generating an aggregated feed interface, the aggregated interface system can generate an aggregate summary from thread data extracted from multiple data feeds of a user account. For instance, the aggregated interface system can extract digital communications and/or contextual activity data from data feeds generated by, or otherwise associated with, various computer applications linked to a user account.

As just mentioned, the aggregated interface system can generate an aggregate summary for a user account. To elaborate, the aggregated interface system can generate the aggregate summary from thread data extracted from various data feeds associated with a user account. For instance, the aggregated interface system can extract, from various data feeds (each of which may correspond to a respective computer application), thread data in the form of digital communications and/or contextual activity data indicating computer processes performed (by servers or client devices) to execute a particular function within a computer application. The aggregated interface system can further generate an aggregate summary to summarize, aggregate, or condense the extracted thread data.

As noted, the aggregated interface system can condense or consolidate thread data from multiple data feeds or applications into aggregate summaries. To condense or consolidate thread data (e.g., multiple digital communications) across different data threads into a single aggregate summary, the aggregated interface system can determine topics associated with the thread data and can generate an aggregate summary from thread data specific to a topic. Across the data feeds and their respective applications, the aggregated interface system can determine various topics reflected by digital content defined by thread data (extracted from the feeds). In some cases, the aggregated interface system utilizes natural language processing or a large language model to determine topics associated with the thread data, and further generates topic-specific aggregate summaries to include within an aggregated feed interface.

Along these lines, the aggregated interface system can generate an aggregated feed interface that presents or includes topic-specific aggregate summaries generated from multiple data feeds of a user account (from a single computer application or across multiple computer applications). In some cases, the aggregated interface system can rank the aggregate summaries and/or other non-summary messages or content included in the aggregated feed interface. For example, the aggregated interface system can implement a ranking algorithm that is customized on a per-account basis to tailor the aggregated feed interface to a user account. Specifically, the aggregated interface system can apply ranking weights to aggregate summaries and other content based on factors such as account activity history in relation to summary-related topics (and/or with user accounts from which digital communications originate) and others. The aggregated interface system can further present aggregate summaries and other content within the aggregated feed interface in an order based on the ranking (e.g., highest-ranked first).

As suggested above, through one or more of the embodiments mentioned above (and described in further detail below), the aggregated interface system can provide several improvements or advantages over existing digital content systems. For example, the aggregated interface system can improve flexibility over prior systems. Indeed, while some prior systems are rigidly fixed to generating and providing digital communications (or other thread data) on a single-platform basis, the aggregated interface system can generate aggregate summaries from thread data across multiple platform-specific data feeds (e.g., for different computer applications). In some cases, the aggregated interface system can also generate digital communications (and other content, such as insights or query responses) for multiple platforms (e.g., feeds or applications) using a single, centralized user interface.

Due at least in part to its improved flexibility, the aggregated interface system can also improve efficiency over existing digital content systems. For example, as opposed to prior systems that consume excessive amounts of computer resources, such as processing power and memory, by running separate applications (and displaying corresponding interfaces) for presenting and generating digital communications (and other thread data) in various platform-specific formats, the aggregated interface system can utilize a single interface—the aggregated feed interface—to condense, centralize, aggregate, or consolidate, the presentation and generation of digital communications (and other thread data) into a single interface of a single application. For example, the aggregated interface system can generate an aggregated feed interface that depicts aggregate summaries of digital communications (and other thread data) from various data feeds of a user account.

Consequently, the aggregated interface system also provides a more efficient, improved user interface over prior systems. Indeed, the aggregated interface system reduces the number of operations to access desired data and/or functionality compared to prior systems. Specifically, the aggregated interface system generates an aggregated feed interface that centralizes the presentation of thread data across multiple data threads which previously required multiple interfaces or applications. Thus, the aggregated interface system not only improves computational efficiency but also improves navigational efficiency providing a more efficient graphical user interface than is available in prior systems.

As illustrated by the foregoing discussion, the present disclosure utilizes a variety of terms to describe features and benefits of the aggregated interface system. Additional detail is hereafter provided regarding the meaning of these terms as used in this disclosure. As used herein, the term “digital content item” (or simply “content item”) refers to a digital object or a digital file that includes information interpretable by a computing device (e.g., a client device) to present information to a user. A digital content item can include a file or a folder such as a digital text file, a digital image file, a digital audio file, a webpage, a website, a digital video file, a web file, a link, a digital document file, or some other type of file or digital object. A digital content item can have a particular file type or file format, which may differ for different types of digital content items (e.g., digital documents, digital images, digital videos, or digital audio files). In some cases, a digital content item can refer to a remotely stored (e.g., cloud-based) item or a link (e.g., a link or reference to a cloud-based item or a web-based content item) and/or a content clip that indicates (or links/references) a discrete selection or segmented sub-portion of content from a webpage or some other content item or source. A content item can also include application-specific content that is siloed to a particular computer application but is not necessarily accessible via a file system or via a network connection. A digital content item can be editable or otherwise modifiable and can also be sharable from one user account (or client device) to another. In some cases, a digital content item is modifiable by multiple user accounts (or client devices) simultaneously and/or at different times.

As mentioned, the aggregated interface system can generate an aggregated feed interface. As used herein, the term “aggregated feed interface” refers to a graphical user interface presented or displayed via a client device that includes one or more aggregate summaries. In particular, an aggregated feed interface includes a visual portrayal or depiction of aggregate summaries and/or other content items within a single scrollable interface. For example, an aggregated feed interface includes or depicts aggregates summaries (and/or other content items) in a ranked order based on a ranking algorithm.

Relatedly, the term “aggregate summary” refers to a specific type of content item that is generated from, and condenses or summarizes, thread data across multiple data feeds of a user account (or multiple user accounts). For example, an aggregate summary includes a computer-generated summary of thread data extracted from multiple data feeds, either from a single computer application or across multiple computer applications. In some cases, an aggregate summary is generated by a summary generation model, such as a large language model or another type of neural network. In these or other cases, an aggregate summary is specific to a single “topic” which refers to a subject matter or subject matter cluster of content reflected, depicted, portrayed, defined, or described by one or more content items.

Along these lines, the term “thread data” refers to one or more types of content items extracted or determined from data feeds. For example thread data can include a “digital communication,” such as an electronic message transmitted over a computer network that is displayable on a client device and/or “contextual activity data,” such as computer processes performed by a device or a server to execute a particular computer function (e.g., to generate or edit a content item, to perform operations on a debugging ticket, to generate computer code). Contextual activity data can also include application identifiers and process identifiers to indicate which process is performed as part of which application as part of executing a certain function. In some cases, thread data refers to individual data elements within content items, such as: i) words and/or images in digital communications, ii) words and/or images in social media posts, iii) progress indicators in project collaboration trackers, and/or iv) processes performed (by servers or devices) to execute a function.

Relatedly, the term “data feed” refers to a feed or channel from which thread data is extracted. In particular, a data feed includes a channel of computer data indicating communication and/or processes performed by devices of a user account. For example, a data feed can include a channel within a digital communication platform, such as SMS text message, email, SLACK, or another instant messaging platform. As another example, a data feed can include a social media platform, a debugging ticket platform (e.g., JIRA), and/or a project collaboration tracker that indicates completion progress of components within a project, which accounts are involved in which components, when progress is made on the project, and so forth. A single computer application or platform can include or facilitate multiple data feeds (e.g., message feeds) for a user account.

As indicated above, the aggregated interface system can generate an aggregate summary of thread data using a summary generation model. As used herein, the term “summary generation model” refers to a machine learning model that generates an aggregate summary from thread data. For example, a summary generation model can refer to a large language model or another type of neural network that generates an aggregate summary from input thread data, including digital communications and/or contextual activity data.

As mentioned above, the aggregated interface system can generate or identify content items using a large language model. As used herein, the term “large language model” refers to a machine learning model trained to perform computer tasks to generate or identify content items in response to trigger events (e.g., user interactions, such as text queries and button selections). In particular, a large language model can be a neural network (e.g., a deep neural network or a transformer neural network) with many parameters trained on large quantities of data (e.g., unlabeled text) using a particular learning technique (e.g., self-supervised learning). For example, a large language model can include parameters trained to generate or identify content items based on various contextual data, including graph information from a knowledge graph and/or historical user account behavior.

Relatedly, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the aggregated interface system utilizes a large language machine learning model in the form of a neural network.

Along these lines, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., content items) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, a diffusion neural network, or a generative adversarial neural network. Upon training, such a neural network may become a large language model.

In some cases, the aggregated interface system utilizes a topic extractor model to determine or extract topics from thread data. As used herein, the term “topic extractor model” refers to a model (e.g., a machine learning model or a neural network), such as a large language model that generates, from input thread data, a set of predicted topics (e.g., in the form of topic labels) along with their respective confidence scores or probabilities. In some cases, a topic extractor model includes all or part of a summary generation model and can determine a topic by first generating a summary of thread data (e.g., of a digital communication) and then determining the topic from the generated summary.

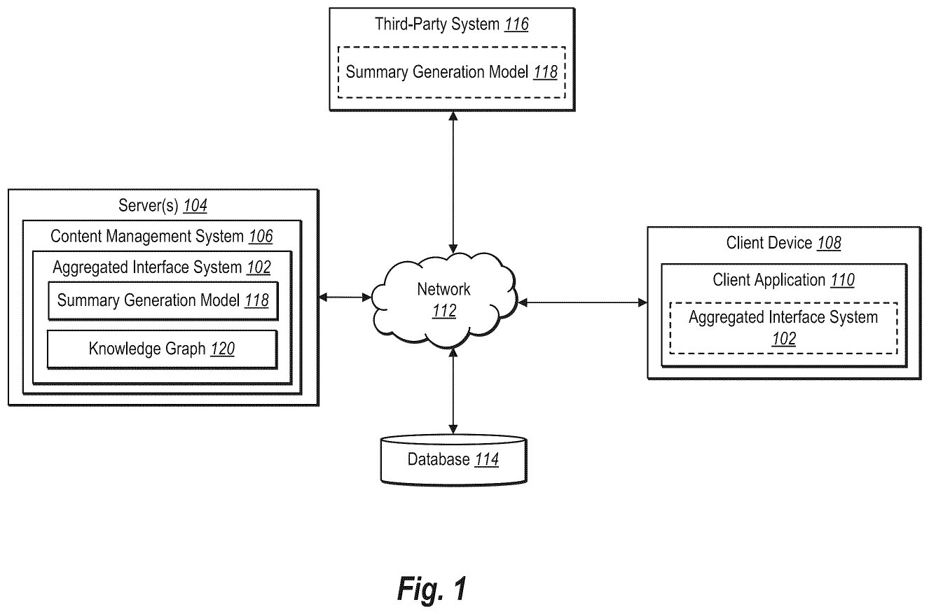

Additional detail regarding the aggregated interface system will now be provided with reference to the figures. For example, FIG. 1 illustrates a schematic diagram of an example system environment for implementing an aggregated interface system 102 in accordance with one or more implementations. An overview of the aggregated interface system 102 is described in relation to FIG. 1. Thereafter, a more detailed description of the components and processes of the aggregated interface system 102 is provided in relation to the subsequent figures.

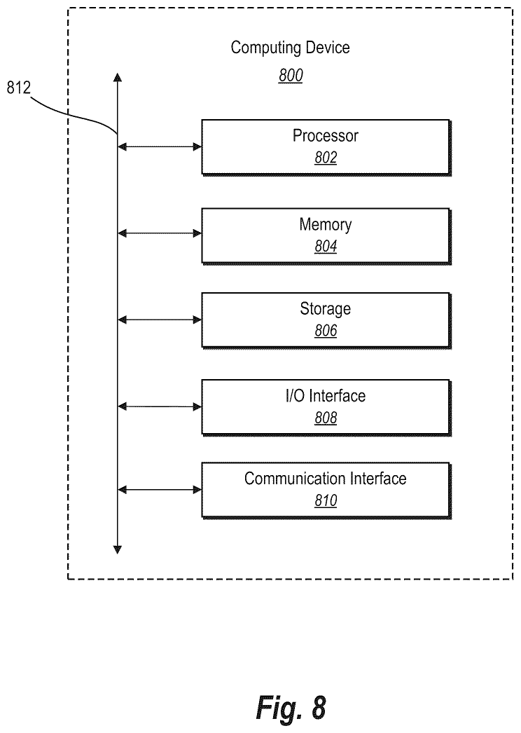

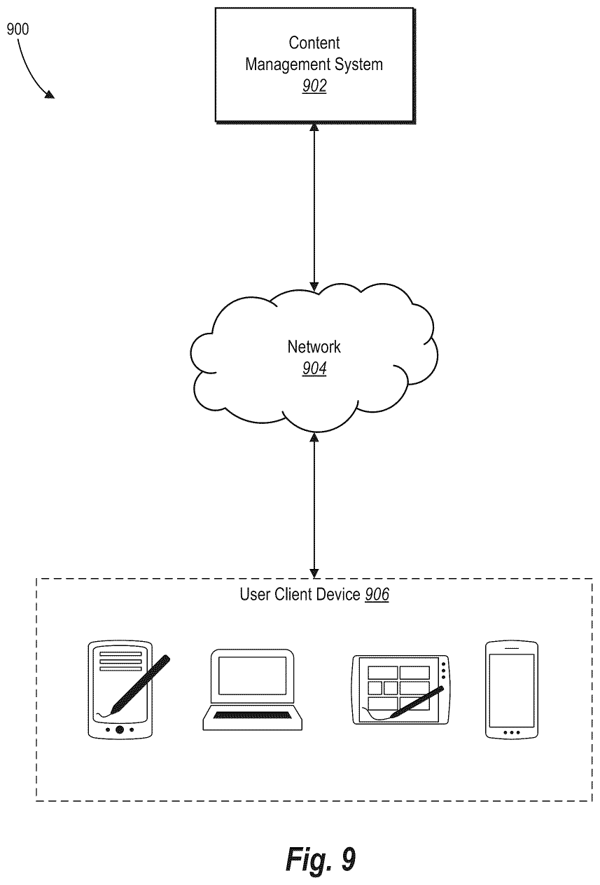

As shown, the environment includes server(s) 104, a client device 108, a database 114, a third-party system 116, and a network 112. Each of the components of the environment can communicate via the network 112, and the network 112 may be any suitable network over which computing devices can communicate. Example networks are discussed in more detail below in relation to FIGS. 8-9.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 8-9. The client device 108 can communicate with the server(s) 104 and/or the database 114 via the network 112. For example, the client device 108 can receive user input from a user interacting with the client device 108 (e.g., via the client application 110) to, for instance, access, generate, modify, or share a content item, to collaborate with a co-user of a different client device, or to select a user interface element. In addition, the aggregated interface system 102 on the server(s) 104 can receive information relating to various interactions with content items and/or user interface elements based on the input received by the client device 108 (e.g., to select an aggregate summary, generate a query response from thread data, or perform some other action).

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including an aggregated feed interface for presenting aggregate summaries and/or other digital content.

As illustrated in FIG. 1, the example environment also includes the server(s) 104. The server(s) 104 may generate, track, store, process, receive, and transmit electronic data, such as digital content items, thread data, aggregate summaries, interface elements, interactions with digital content items, interactions with interface elements, and/or interactions between user accounts or client devices. For example, the server(s) 104 may receive data from the client device 108 (or from other client devices) in the form of thread data, such as digital communications and/or contextual thread data. In addition, the server(s) 104 can transmit data to the client device 108 in the form of an aggregated feed interface that includes an aggregate summary generated from the received thread data. Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning server, and other types of servers.

As shown in FIG. 1, the server(s) 104 can also include the aggregated interface system 102 as part of a content management system 106. The content management system 106 can communicate with the client device 108 to perform various functions associated with the client application 110 such as managing user accounts, managing content collections, managing content items, and facilitating user interaction with the content collections and/or content items. Indeed, the content management system 106 can include a network-based smart cloud storage system to manage, store, and maintain content items and related data across numerous user accounts, including user accounts in collaboration with one another. In some embodiments, the aggregated interface system 102 and/or the content management system 106 utilize the database 114 to store and access information such as digital content items.

As also illustrated in FIG. 1, the aggregated interface system 102 can include a summary generation model 118 and a knowledge graph 120. In particular, the aggregated interface system 102 can utilize the summary generation model 118 that is integrated with (e.g., trained by data from) the content management system 106 and/or the knowledge graph 120. For example, the knowledge graph 120 can store or encode relationship information to define relationships between user accounts and thread data within the content management system 106 (and/or housed at other server locations). From the knowledge graph 120, the summary generation model 118 can generate account-specific aggregate summaries from thread data to provide to the client device 108. For instance, the summary generation model 118 can generate an aggregate summary that summarizes thread data from multiple data feeds of the client device 108 and that includes and omits thread data as determined via the knowledge graph 120.

FIG. 1 further illustrates a third-party system 116. In particular, the third-party system 116 can host or house a summary generation model 118 for access by the aggregated interface system 102. For example, the third-party system 116 can include a server location hosting the summary generation model 118 that is external to the aggregated interface system 102. In some cases, the third-party system 116 is external to the aggregated interface system 102, but the aggregated interface system 102 can nevertheless access and utilize the summary generation model 118 to generate or identify content items by analyzing a knowledge graph 120 on the server(s) 104.

Although FIG. 1 depicts the aggregated interface system 102 located on the server(s) 104, in some implementations, the aggregated interface system 102 may be implemented by (e.g., located entirely or in part on) one or more other components of the environment. For example, the aggregated interface system 102 may be implemented by the client device 108, and/or a third-party device. For example, the client device 108 can download all or part of the aggregated interface system 102 for implementation independent of, or together with, the server(s) 104.

In some implementations, though not illustrated in FIG. 1, the environment may have a different arrangement of components and/or may have a different number or set of components altogether. For example, the client device 108 may communicate directly with the aggregated interface system 102, bypassing the network 112. As another example, the environment can include the database 114 located external to the server(s) 104 (e.g., in communication via the network 112) or located on the server(s) 104, on the third-party system 116, and/or on the client device 108.

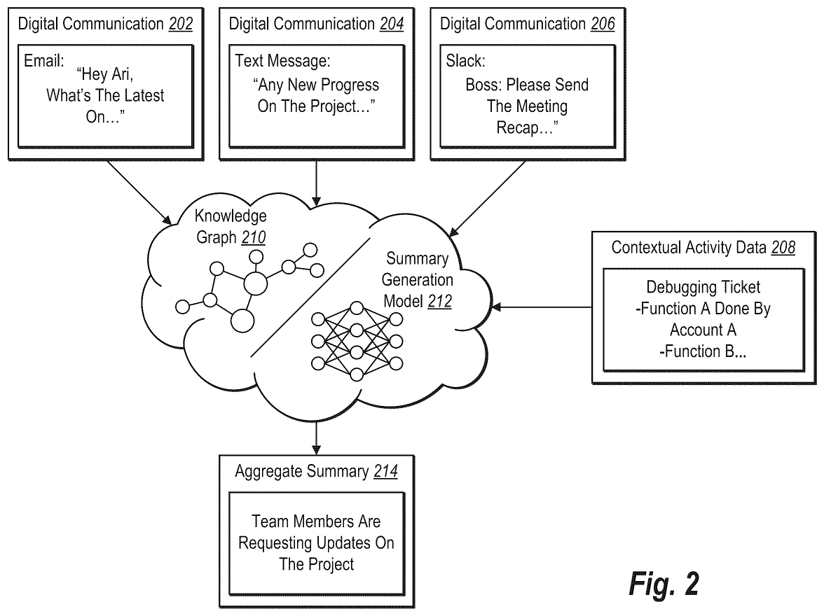

As mentioned above, the aggregated interface system 102 can generate and provide an aggregate summary by analyzing and summarizing thread data from multiple data feeds associated with a user account. In particular, the aggregated interface system 102 can generate an aggregate summary from digital communications and/or contextual activity data of a user account. FIG. 2 illustrates an overview of generating an aggregate summary from thread data in accordance with one or more embodiments. Additional detail regarding the various acts and processes described in relation to FIG. 2 is provided thereafter with reference to subsequent figures.

As illustrated in FIG. 2, the aggregated interface system 102 accesses, receives, determines, or detects thread data from multiple data feeds. More specifically, the aggregated interface system 102 identifies data feeds of a user account by detecting digital communications involving the user account and/or by detecting contextual activity data performed by a client device and/or a server to execute a computer function for the user account. For example, the aggregated interface system 102 integrates or links data feeds using application programming interfaces (APIs) or custom-coded integrations to access or collect thread data from the various data feeds. In some cases, the aggregated interface system 102 utilizes APIs made available by source applications that host the various data feeds associated with the user account.

As shown, the aggregated interface system 102 identifies thread data from a digital communication 202, a digital communication 204, a digital communication 206, and contextual activity data 208. Specifically, the digital communication 202 is an email transmitted over a computer network (e.g., the network 112) using email protocol (a first data feed), the digital communication 204 is a text message transmitted over a computer network using a text messaging protocol (a second data feed), and the digital communication 206 is a SLACK message transmitted over a computer network using a SLACK messaging protocol (a third data feed). In addition, the contextual activity data 208 is from a fourth data feed and indicates computer processes performed (in response to user interactions with a client device) by a client device or a server in relation to a debugging ticket (e.g., Function A and Function B which are debugging functions for fixing and/or texting a reported software bug).

From the thread data, as shown in FIG. 2, the aggregated interface system 102 generates an aggregate summary 214 utilizing a knowledge graph 210 and/or a summary generation model 212. To elaborate, the aggregated interface system 102 ingests the thread data from the respective data feeds and utilizes the summary generation model 212 to generate the aggregate summary 214 that summarizes or condenses the information, or the thread data, from the various data feeds in an account-specific fashion.

For example, the aggregated interface system 102 determines a topic for each of the thread data received from the data feeds. In addition, the aggregated interface system 102 compares the thread-data-specific topics by for example, using a clustering technique (e.g., k-means clustering) and/or determining distances (or cosine similarities) between latent vector representations of the thread data (or the topics) within a latent space. In some cases, based on such a comparison, the aggregated interface system 102 determines that thread data from different data feeds is related and is combinable within a single aggregate summary. For instance, the aggregated interface system 102 determines that information from multiple digital communications and/or contextual activity data are combinable into an aggregate summary.

In some embodiments, based on determining that the digital communication 202, the digital communication 204, the digital communication 206, and the contextual activity data 208 are all related to a shared topic, the aggregated interface system 102 further utilizes the summary generation model 212 to generate the aggregate summary 214. Indeed, the aggregated interface system 102 generates the aggregate summary 214 to summarize or condense thread data from the digital communication 202, the digital communication 204, the digital communication 206, and the contextual activity data 208. In some cases, the aggregated interface system 102 utilizes the summary generation model 212 to generate the aggregate summary 214 by summarizing information across the data threads (e.g., from different data feeds and/or different computer applications). In some embodiments, the summary generation model 212 generates a summary of the thread data from each data feed and further generates the aggregate summary 214 by combining or summarizing the intermediate data-feed-specific summaries.

In certain embodiments, the knowledge graph 210 informs summary generation. To elaborate, the aggregated interface system 102 utilizes the knowledge graph 210 to determine or identify relationships between thread data (or data feeds) and a user account. For example, the aggregated interface system 102 determines past actions and other knowledge graph information in relation to data feeds (e.g., previous participation in a message thread), relationships with co-user accounts (e.g., an email originating from a manager account) that impact the relevance of thread data, and/or past actions with content items corresponding to a topic shared by thread data (e.g., previous views or accesses of digital images depicting content relating to a message thread). In some cases, the knowledge graph refers to a knowledge graph described by Devin Mancuso et al. in U.S. patent application Ser. No. 18/342,469 titled GENERATING AND PROVIDING MORPHING ASSISTANT INTERFACES THAT TRANSFORM ACCORDING TO ARTIFICIAL INTELLIGENCE SIGNALS, filed Jun. 27, 2023, which is hereby incorporated by reference in its entirety.

In some embodiments, the aggregated interface system 102 trains or tunes the summary generation model 212 using information from the knowledge graph 210. More specifically, the aggregated interface system 102 tunes the summary generation model 212 to generate the aggregate summary 214 from thread data that is relevant to a user account, while omitting (or de-emphasizing) less relevant thread data. For example, if the aggregated interface system 102 identifies three digital communications that share a common topic, two of which are relevant to the user account (as indicated by the knowledge graph 21), the aggregated interface system 102 can generate the aggregate summary 214 from only the two relevant digital communications (or from all three with less emphasis on the irrelevant one, where it is less impactful on the ultimate summary).

In one or more embodiments, the aggregated interface system 102 further utilizes information from the knowledge graph 210 for ranking thread data and/or aggregate summaries (e.g., the aggregate summary 214). Particularly, the aggregated interface system 102 generates multiple aggregate summaries and determines relevance of the aggregate summaries in relation to a user account (e.g., based on user activity, relevant topics, co-user account relationships, and other information encoded by the knowledge graph 210). Accordingly, the aggregated interface system 102 determines, based on the relevance as well as other factors of a ranking algorithm, a ranking for aggregate summaries (and other content items) to present within an aggregated feed interface for display on a client device.

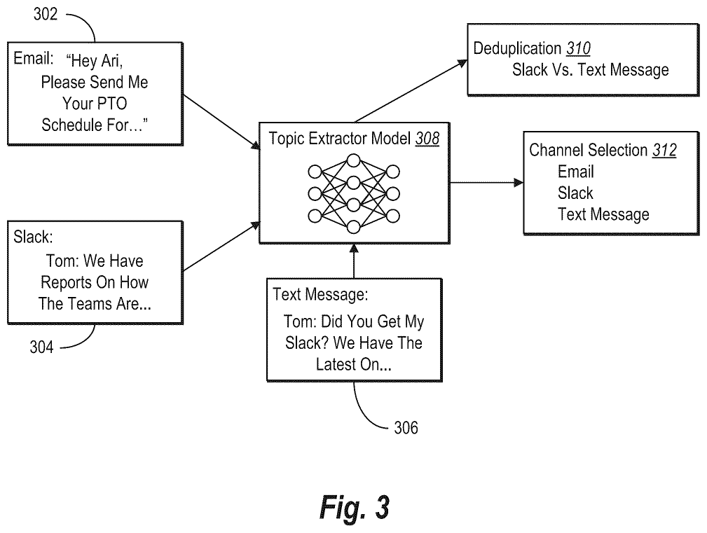

As mentioned above, in certain described embodiments, the aggregated interface system 102 determines topics associated with thread data as part of generating aggregate summaries. In particular, the aggregated interface system 102 generates aggregate summaries based on thread data topics, along with a deduplication process and a channel selection process informed by the topics. FIG. 3 illustrates an example diagram for determining topics and performing other functions based on the topics in accordance with one or more embodiments.

As illustrated in FIG. 3, the aggregated interface system 102 utilizes a topic extractor model 308 to generate or extract topics from thread data. More specifically, the aggregated interface system 102 determines topics by generating topic labels for subject matter described or depicted by thread data of various data feeds. For example, the aggregated interface system 102 identifies data feeds associated with a user account, such as digital communication threads and other computer applications performing processing for executing a computer function, such as updating a debugging ticket, performing debugging processes, or generating/modifying a content item. As shown, the aggregated interface system 102 receives a digital communication 302 (e.g., an email from an email data feed), a digital communication 304 (e.g., a SLACK message from a SLACK data feed), a digital communication 306 (e.g., a text message from a text message data feed). From the digital communications, the aggregated interface system 102 generates or determines topic labels indicating subject matter depicted or described from the content of each of the thread data (e.g., from a single digital communication or a collection of digital communications in a thread). In some cases, the aggregated interface system 102 determines topics such as “Project X” for a work project, “dinosaurs,” “cars,” “clothing,” or more complicated, multifaceted topics such as “economic impacts of global warming on communities in the Pacific islands” or “history of French colonialism in southeast Asia from 1890-1920.”

In some embodiments, the topic extractor model 308 also compares extracted topics. To elaborate, the aggregated interface system 102 utilizes the topic extractor model 308 to compare topics from different digital communications (and/or from contextual activity data). For example, the topic extractor model 308 extracts or generates a topic vector (e.g., a latent vector) to represent a topic in a latent feature space. The topic extractor model 308 can further compare topic vectors within the latent feature space to determine distances, cosine similarities, and/or clusters (using a clustering algorithm) to determine relatedness between extracted topics. Accordingly, the topic extractor model 308 can determine or identify thread data, such as digital communications, that share common topics with one another. Downstream, the aggregated interface system 102 can thus combine thread data that share a topic into an aggregate summary across multiple data feeds.

As further illustrated in FIG. 3, the aggregated interface system 102 performs a deduplication 310. More specifically, the aggregated interface system 102 deduplicates thread data, such as digital communications and contextual activity data based on extracted topics and/or other information. For example, the aggregated interface system 102 identifies digital communications related to a common topic as candidates for deduplication. In some cases, the aggregated interface system 102 performs further textual analysis of thread data extracted deduplication candidates to determine a similarity metric or an overlap metric that informs the deduplication process. For example, the aggregated interface system 102 determines an added distance that reflects a number of operations that would convert or alter one digital communication to exactly match another. As another example, the aggregated interface system 102 determines an amount or a percentage of matching content as an overlap metric.

If the overlap metric satisfies a threshold, the aggregated interface system 102 determines that the digital communications (or other thread data, such as debugging thread updates or social media posts) are duplicative, and the aggregated interface system 102 selects one of the digital communicates to omit or exclude from the aggregate summary generation process. In some embodiments, the aggregated interface system 102 selects the digital communication to deduplicate based on relevance to a user account. For instance, the aggregated interface system 102 deduplicates a digital communication that is less relevant (e.g., based on a ranking algorithm) than another digital communication (e.g., a digital communication from a co-user account with a close relationship as indicated by a knowledge graph versus a digital communication from a co-user with a farther relationship). In some cases, the aggregated interface system 102 further compares data feeds and originating user accounts associated with thread data and only deduplicates if thread data originates from a shared data feed and/or from the same originating user account.

As also illustrated in FIG. 3, the aggregated interface system 102 performs a channel selection 312. In particular, the aggregated interface system 102 selects a channel, or a data feed, for communicating in relation to a particular topic (or a particular aggregate summary). Indeed, based on determining candidate data feeds that share a common topic, the aggregated interface system 102 can determine data feed metrics for the candidate data feeds. In addition, the aggregated interface system 102 compares data feed metrics among the data feeds to compare their relevance to a user account. In some cases, the aggregated interface system 102 determines and compares data feed metrics, such as a number of user accounts communicating about a particular topic within the data feed, the relationships of the communicating co-user accounts with a user account, a frequency of a user account interacting within the data feed, a recency of a user account interacting within the data feed, and/or a number and/or types of (and/or a frequency of interaction with) content items stored for a user account that correspond to the particular topic of the data feed.

Based on the data feed metrics, the aggregated interface system 102 can determine data feed scores for the respective data feeds and can select a data feed as a communication channel for the user account to communicate (e.g., to generate and transmit digital communications) about the topic. In some cases, the aggregated interface system 102 may determine that a SLACK channel is the best data feed for a user account to communicate regarding a first topic, while in other cases the aggregated interface system 102 may determine that a text message thread is the best data feed for the user account to communicate regarding a second topic. In one or more embodiments, the aggregated interface system 102 also or alternatively performs the channel selection 312 by selecting a data feed that includes the most (or most relevant and/or most information) information relating to the specific topic.

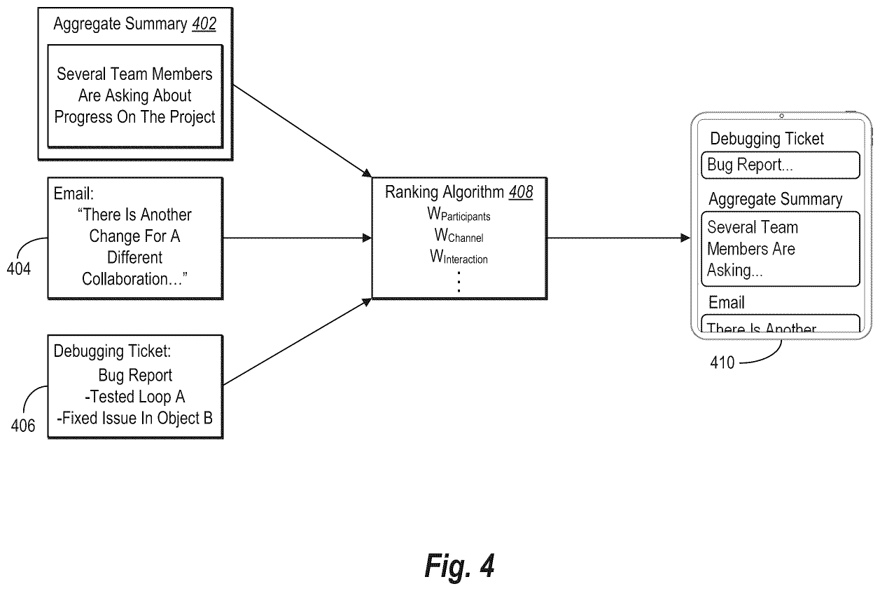

As noted above, in certain embodiments, the aggregated interface system 102 generates and provides an aggregated feed interface for display on a client device. As part of generating the aggregated feed interface, the aggregated interface system 102 can rank aggregate summaries using a ranking algorithm. FIG. 4 illustrates an example diagram for ranking aggregate summaries and other content items in accordance with one or more embodiments.

As illustrated in FIG. 4, the aggregated interface system 102 generates an aggregate summary 402. In particular, the aggregated interface system 102 generates the aggregate summary 402 by using a summary generation model, such as a large language model, to summarize, shorten, or condense thread data from multiple data feeds associated with a user account. Specifically, the aggregated interface system 102 identifies digital communications and/or contextual activity data associated with a common topic and/or that include common participating user accounts. The aggregated interface system 102 further generates an aggregate summary from the identified digital communications and/or contextual activity data.

For example, the aggregated interface system 102 generates a prompt to provide to a summary generation model by generating summaries of individual digital communications (or contextual activity data and/or other thread data) and/or by selecting portions of the intermediate summaries to include within the prompt. Specifically, the aggregated interface system 102 partitions an intermediate summary (or an initial digital communication from which the intermediate summary is generated) into segments having a particular (equal) number of tokens and selects a number of segments to include within a prompt. In addition, the aggregated interface system 102 adds segments from other (topic-related) intermediate summaries (or thread data) to the prompt. The aggregated interface system 102 further provides the prompt to the summary generation model to generate the aggregate summary 402.

As also illustrated in FIG. 4, the aggregated interface system 102 identifies or receives a digital communication 404 and contextual activity data 406 to include within an aggregated feed interface. For example, the aggregated interface system 102 determines that the digital communication 404 and the contextual activity data 406 are related to topics (and/or user accounts) not common with other thread data and that, therefore, they are to be presented individually within an aggregated feed interface. The aggregated interface system 102 further utilizes a ranking algorithm 408 to rank the aggregate summary 402, the digital communication 404, and the contextual activity data 406 for determining the order or placement of each within an aggregated feed interface.

As part of the ranking algorithm 408, the aggregated interface system 102 determines and applies weights to displayable elements for an aggregated feed interface, including the aggregate summary 402, the digital communication 404, and/or the contextual activity data 406. In some embodiments, the ranking algorithm 408 is a personalized ranking algorithm specific to a user account, where the algorithm applies weights to thread data (or aggregate summaries) according to an activity history of the user account (and/or according to other data encoded in a knowledge graph). For example, the ranking algorithm 408 incorporates a number of ranking factors, including a weight for participating user accounts, a weight for time-based factors, a weight for a data feed associated with thread data or an aggregate summary, a weight for a topic associated with thread data or an aggregate summary, and/or a weight (or a boost) for user account interaction with a topic or a data feed associated with the thread data or an aggregate summary. In some cases, the ranking algorithm 408 is based on bidirectional encoder representations from transformers (BERT) and is trained to determine features from natural language text.

As just mentioned, in some embodiments, the ranking algorithm 408 applies topic weights to the aggregate summary 402, the digital communication 404, and/or the contextual activity data 406. For example, the aggregated interface system 102 determines topics associated with the aggregate summary 402, the digital communication 404, and/or the contextual activity data 406 as described herein. The ranking algorithm 408 can further apply topic-specific weights where some topics are weighted more heavily than other topics. For example, the ranking algorithm 408 can determine topics relevant to a user account based on knowledge graph data (e.g., user account activity in relation to content items associated with the topic and/or within data feeds corresponding to the topic, as well as how recent and how frequent the interactions occur) and can further compare relevant topics with topics of (and/or actual content within) the aggregate summary 402, the digital communication 404, and/or the contextual activity data 406. Specifically, the ranking algorithm 408 can extract topic vectors from the relevant topics and can further extract vectors from the aggregate summary 402, the digital communication 404, and/or the contextual activity data 406 to compare within a latent vector space (e.g., using a cosine similarity or a distance determination). Based on such a comparison, the ranking algorithm 408 can determine similarities or rankings for the aggregate summary 402, the digital communication 404, and/or the contextual activity data 406.

As mentioned, the ranking algorithm 408 can apply weights for time-based factors. For example, the ranking algorithm 408 applies weights to data indicating timing of when thread data is generated and/or when a user account interacts with the thread data. Indeed, the ranking algorithm 408 can rank the aggregate summary 402, the digital communication 404, and/or the contextual activity data 406 based on when each was generated, how recently the user account (or a threshold number of co-user accounts with close relationships to the user account) interacted with them, and/or how frequently the user account (or a threshold number of co-user accounts with close relationships to the user account) interact with them. Such user interactions can include selecting or viewing the aggregate summary 402, the digital communication 404, and/or the contextual activity data 406. User interactions can also or alternatively include replying to the digital communication 404, updating the contextual activity data 406 (e.g., by adding a new debugging report to the debugging ticket and/or by generating code to fix a reported bug), and/or selecting an option for requesting further information regarding the aggregate summary 402.

In one or more embodiments, the ranking algorithm 408 can also or alternatively weight factors relating to participating user accounts as part of ranking the aggregate summary 402, the digital communication 404, and/or the contextual activity data 406. For example, the aggregated interface system 102 can determine a number of user accounts associated with (e.g., participating in, generating messages for, responding to, and/or performing actions in relation to) each of the aggregate summary 402, the digital communication 404, and/or the contextual activity data 406. In some cases, the aggregated interface system 102 utilizes a knowledge graph to determine relationships between the user accounts and the aggregate summary 402, the digital communication 404, and/or the contextual activity data 406. In some cases, the ranking algorithm 408 thus applies a participant's weight reflecting the number of participating user accounts, where more user accounts result in a heavier weight and a higher rank. In some embodiments, the ranking algorithm 408 also or alternatively applies a participant's weight that reflects (in addition to the number) the relationships of the participating user accounts in relation to a specific user account (e.g., a user account of the client device 410), such that closer relationships (as indicated by a knowledge graph) result in heavier weights and higher ranks.

In one or more embodiments, the ranking algorithm 408 can further apply a ranking boost to the aggregate summary 402, the digital communication 404, and/or the contextual activity data 406. Specifically, the ranking algorithm 408 applies a ranking boost based on determining or detecting user account activity interacting with one or more of the aggregate summary 402, the digital communication 404, and/or the contextual activity data 406. If the user account interacts with the aggregate summary 402 (e.g., by interacting with content items relating to a common topic and/or by generating or responding to digital communications or contextual activity data used to generate the aggregate summary 402), the ranking algorithm 408 applies an interaction boost to the aggregate summary 402. Likewise, if the user account interacts with the digital communication 404 (e.g., by viewing it, selecting it, or replying to it), the ranking algorithm 408 applies an interaction boost to the digital communication 404. In some cases, the ranking algorithm 408 applies different interaction boosts for different types of user interaction, where, for example, replying to the digital communication 404 warrants a heavier weight than viewing or selecting the digital communication 404, both of which warrant heavier weights than viewing other content items relating to the topic of the digital communication 404.

Based on ranking the aggregate summary 402, the digital communication 404, and/or the contextual activity data 406, the aggregated interface system 102 can generate and provide an aggregated feed interface. As shown in FIG. 4, the aggregated interface system 102 can generate an aggregated feed interface for display on a client device 410. The aggregated feed interface includes visual representations of the aggregate summary 402, the digital communication 404, and/or the contextual activity data 406 in order of their respective rankings.

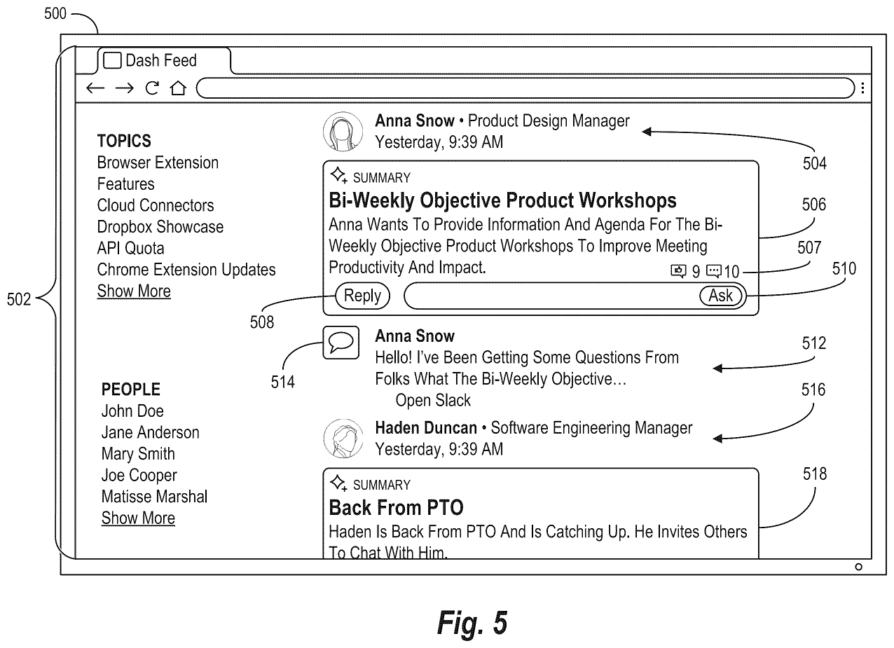

As just mentioned, in certain described embodiments, the aggregated interface system 102 generates an aggregated feed interface that includes (in ranked order) a number of content items, such as aggregate summaries, digital communications, and/or other visual indicators. For example, an aggregated feed interface can include selectable elements for interacting with aggregate summaries and/or graphical indicators signifying one or more source data feeds for an aggregate summary. FIG. 5 illustrates an example aggregated feed interface in accordance with one or more embodiments.

As illustrated in FIG. 5, a client device 500 displays or presents an aggregated feed interface 502. The aggregated feed interface 502 includes an aggregate summary 506. In particular, the aggregated interface system 102 generates and provides the aggregate summary 506 which summaries thread data across multiple data feeds of a user account. As shown, the aggregate summary 506 includes a graphical indication (e.g., the star shapes in the upper-left and the “Summary” label) designating it as an aggregate summary generated from thread data of multiple data feeds using machine learning techniques (described above).

In addition, the aggregate summary 506 includes a reply option 508. In particular, based on receiving an indication of a user interaction selecting the reply option 508, the aggregated interface system 102 determines or selects a data feed for replying (as described above) and provides an option (e.g., a pop-up window or an expanded view of the aggregate summary 506 to include a text field for typing the reply) for generating a reply message to send in relation to the aggregate summary 506. The aggregated interface system 102 can thus generate a new digital communication to provide to co-user accounts associated with thread data summarized by the aggregate summary 506. In some cases, the aggregated interface system 102 can further update the aggregate summary 506 based on the reply (and/or in response to replies by co-user accounts).

As shown, the aggregate summary 506 further includes an inquiry element 510. In particular, based on receiving an indication of a user interaction inputting a query within the inquiry element 510, the aggregated interface system 102 provides the query to a large language model to generate a response to the query. To elaborate, the aggregated interface system 102 generates a prompt from the typed query in the inquiry element 510 (and/or that includes all or part of the text from the aggregate summary 506 and/or text segments from thread data used to generate the aggregate summary 506) to provide to a large language model (which is tuned or trained on thread data used to generate the aggregate summary 506). Using the large language model, the aggregated interface system 102 generates or receives a response to the query and modifies the aggregate summary to include or present the response. For example, the aggregated interface system 102 generates a response to a query asking for further information on (or a prediction regarding) the bi-weekly product workshops of the aggregate summary 506.

As also shown in FIG. 5, the aggregate summary 506 includes interaction insights. For example, the aggregated interface system 102 determines or receives interactions from user accounts in relation to the aggregate summary 506 and/or in relation to thread data used to generate the aggregate summary 506. In some cases, the aggregated interface system 102 determines sentiments from other content items, such as digital communications, co-user accounts have generated in relation to the aggregate summary 506 (or the topic of the aggregate summary 506). Based on the interactions, the aggregated interface system 102 generates the interaction insights 507 that visually depict comments, reactions, and/or other interactions from user accounts in relation to the aggregate summary 506. The aggregated interface system 102 can generate the interaction insights 507 by monitoring thread data from data feeds used to generate the aggregate summary 506, determining sentiment scores from the thread data, and/or providing indications of the sentiment as well as quantities of interactions of user accounts in relation to the aggregate summary 506.

In addition, the aggregated feed interface 502 includes a source indicator 504 corresponding to the aggregate summary 506. To elaborate, the aggregated interface system 102 generates and provides the source indicator 504 to designate or signify at least one source of thread data used to generate the aggregate summary 506. For example, the aggregated interface system 102 determines contribution metrics (e.g., Shapley scores) for different sources, such as data feeds and co-user accounts originating thread data, that indicate respective measures of impact of the sources on the ultimate aggregate summary 506 (e.g., based on internal summary generation model features extracted from the sources). The aggregated interface system 102 can further rank the sources based on their contribution measures and generate the source indicator 504 to visually represent the highest ranked source. As shown, the source indicator 504 indicates a user account of Anna Snow as the highest ranked source for the aggregate summary 506.

As further illustrated in FIG. 5, the aggregated feed interface 502 includes a data feed 512 and a feed type indicator 514. In particular, the data feed 512 indicates a data feed that includes thread data used to generate the aggregate summary 506. For example, the aggregated interface system 102 provides the data feed 512 based on determining that the data feed 512 is a highest-ranked source for the aggregate summary based on contribution measures. As another example, the aggregated interface system 102 provides the data feed 512 based on selecting the data feed 512 as the channel for replying to, or communicating about, a topic reflected by the aggregate summary 506. In addition, the aggregated interface system 102 generates and provides the feed type indicator 514 as a graphical visualization of the type of the data feed 512 (e.g., a text message thread or an email chain or a SLACK channel, where each type has a different graphic). Indeed, the aggregated interface system 102 provides the feed type indicator 514 for the selected (or highest-ranked) data feed of the aggregate summary 506.

As also illustrated in FIG. 5, the aggregated feed interface 502 includes an aggregate summary 518 and a source indicator 516 for the aggregate summary 518. Indeed, as described in relation to the aggregate summary 506, the aggregated interface system 102 can generate and provide additional aggregate summaries and their source indicators (and selected data feeds) for display within the aggregated feed interface 502. Indeed, in some cases, the aggregated feed interface 502 is vertically scrollable to view additional content, including aggregate summaries, digital communications, and/or other content items in order of their ranking by a ranking algorithm (e.g., where higher ranks result in presentation nearer to the top).

As further illustrated in FIG. 5, the aggregated feed interface 502 includes a “Topics” panel and a “People” panel (e.g., the panels on the left side of the interface). Within the “Topics” panel, the aggregated interface system 102 provides selectable topic-specific links for accessing content corresponding to various topics. For example, in response to a selection of a “Browser extension” topic, the aggregated interface system 102 identifies aggregate summaries and other content items corresponding to browser extensions to provide for display within the aggregated feed interface 502 (e.g., a filter, omitting other content not related to the topic). For instance, the aggregated interface system 102 can rank the content items based on their relevance to the selected topic (e.g., based on distance or cosine similarity between topic vectors/embeddings extracted from the selected topic and the content items) and can present the content items in ranked order. Similarly, the aggregated interface system 102 can determine and rank aggregate summaries and/or other content items corresponding to user accounts selected from the “People” panel. For instance, the aggregated interface system 102 can identify aggregate summaries and content items that a selected user account has interacted with or generated content for, and the aggregated interface system 102 can rank the content items based on respective levels or measures of interaction with the content items for presentation in the aggregated feed interface 502.

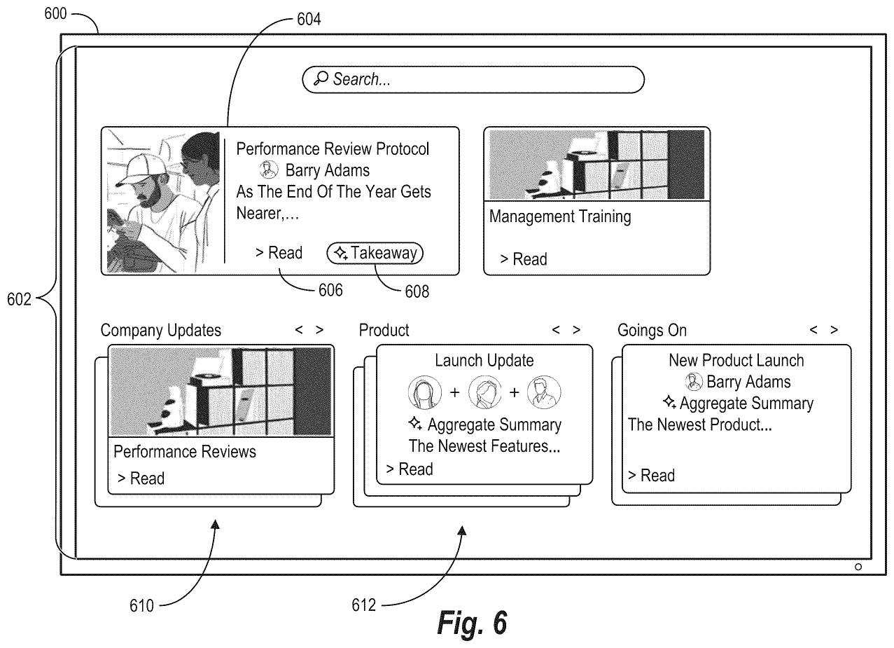

In one or more embodiments, the aggregated interface system 102 generates an alternative view for an aggregated feed interface. For example, the aggregated interface system 102 generates a tickertape-style aggregated feed interface that scroll horizontally instead of vertically. FIG. 6 illustrates another example aggregated feed interface in accordance with one or more embodiments.

As illustrated in FIG. 6, a client device 600 presents or displays an aggregated feed interface 602. In some embodiments, all or some (e.g., the upper portion not including the stacks) of the aggregated feed interface 602 can automatically scroll or pan horizontally revealing a ranked order of content items, such as aggregate summaries, digital communications, and contextual activity data. The aggregated feed interface 602 includes various user interface elements, such as an aggregate summary 604. Indeed, the aggregated interface system 102 generates the aggregate summary 604 as described above by identifying and summarizing thread data relating to a common topic across multiple data feeds. In addition, the aggregated interface system 102 determines a source user account (or data feed) that is most relevant or impactful on the aggregate summary 604 and provides a visual indication of the source (e.g., the profile icon for Barry Adams).

As further illustrated in FIG. 6, the aggregated interface system 102 generates the aggregate summary 604 to include selectable elements for interacting with the aggregate summary 604. For example, the aggregate summary 604 includes a read element 606 that is selectable to view and read the entirety of the aggregate summary 604. Indeed, as shown, the icon for the aggregate summary 604 as shown in the aggregated feed interface 602 may only depict a portion of the entire text of the aggregate summary 604. Thus, upon selection of the read element 606, the aggregated interface system 102 can expand the aggregate summary 604 or provide a pop-up window to present the full text of the summary.

In addition, the aggregated interface system 102 can generate and provide a takeaway element 608. To elaborate, in response to a selection of the takeaway element 608, the aggregated interface system 102 can generate highlights or takeaways from the aggregate summary 604. For example, the aggregated interface system 102 generates a prompt to provide to a large language model, where the prompt requests highlights, bullet points, or takeaways from the aggregate summary 604. The aggregated interface system 102 thus generates or receives a takeaway output from the large language model in the form of sub-topics and/or action items (e.g., content items extracted from text that prompt or request action on the part of a user account).

As further illustrated in FIG. 6, the aggregated interface system 102 arranges content items within the aggregated feed interface 602 according to topics. Specifically, the aggregated interface system 102 generates topic-specific stacks, such as the stack 610 and the stack 612 that each include content items relating to respective topics (e.g., “Company Updates” or “Product”). To generate the stack 610, for instance, the aggregated interface system 102 determines and compares topics for content items, as described herein, and includes content items that are within a threshold similarity of the “Company Updates” vector (e.g., whose topic vectors are within a threshold distance or a threshold cosine similarity of the topic vector for “Company Updates”). As shown, the aggregated interface system 102 can receive user interaction to toggle through content items within the stack 610 and/or the stack 612 (e.g., via the left and right arrows provided for each stack, or by some other mechanism).

In some cases, the aggregated interface system 102 generates topic vectors for aggregate summaries and groups aggregate summaries within the stack 610 and/or the stack 612. As shown, the content item on the top of the stack 612 is an aggregate summary for the topic of “Launch Update” within the stack topic of “Product.” Indeed, the aggregated interface system 102 provides visual indications of the aggregate summary, along with a selectable read option and source indicators (e.g., the three profile icons with “+” signs between them indicating a top number of sources) indicating user accounts or data feeds that include thread data used to generate the aggregate summary.

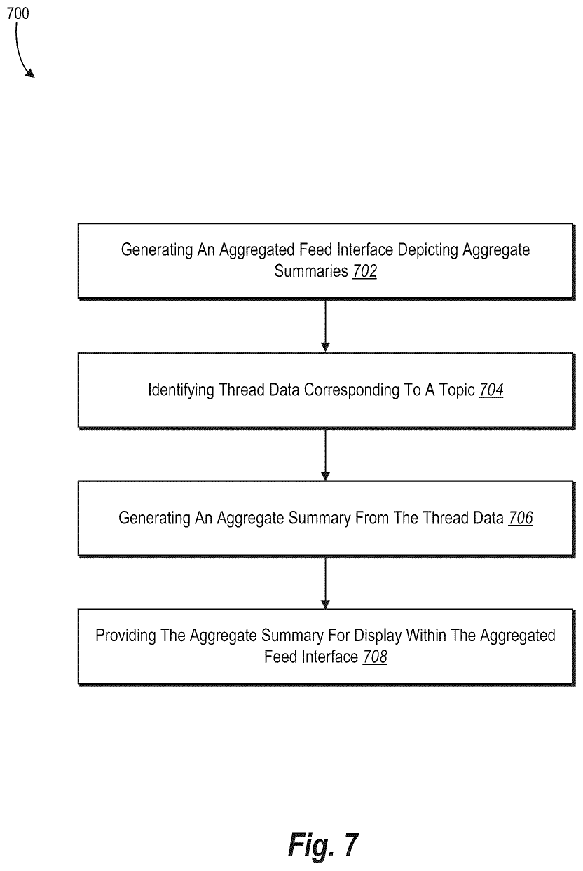

FIGS. 1-6, the corresponding text, and the examples provide a number of different systems and methods for generating and providing aggregate summaries within an aggregated feed interface. In addition to the foregoing, implementations can also be described in terms of flowcharts comprising acts steps in a method for accomplishing a particular result. For example, FIG. 7 illustrates an example series of acts for generating, providing, and transforming an intelligent application interface in accordance with one or more embodiments.

While FIG. 7 illustrates acts according to certain implementations, alternative implementations may omit, add to, reorder, and/or modify any of the acts shown in FIG. 7. The acts of FIG. 7 can be performed as part of a method. Alternatively, a non-transitory computer readable medium can comprise instructions, that when executed by one or more processors, cause a computing device to perform the acts of FIG. 7. In still further implementations, a system can perform the acts of FIG. 7.

As illustrated in FIG. 7, the series of acts 700 may include an act 702 of generating an aggregated feed interface depicting aggregate summaries. For example, the act 702 involves generating, for display on a client device associated with a user account, an aggregated feed interface depicting a plurality of aggregate summaries of thread data extracted from a plurality of data feeds associated with the user account. In addition, the series of acts 700 includes an act 704 of identifying thread data corresponding to a topic. For example, the act 704 involves identifying, from among the plurality of data feeds, a subset of thread data corresponding to a topic. As also shown, the series of acts 700 includes an act 706 of generating an aggregate summary from the thread data. For example, the act 706 involves generating an aggregate summary corresponding to the subset of thread data. In further shown, the series of acts 700 includes an act 708 of providing the aggregate summary for display within the aggregated feed interface. For example, the act 708 involves providing the aggregate summary for display within the aggregated feed interface on the client device.

The series of acts 700 can include an act of generating the aggregated feed interface by generating, for display on the client device, a user interface that includes a visual indication of a data feed used as a source of the subset of thread data for generating the aggregate summary. In some embodiments, the series of acts 700 also includes an act of extracting the thread data from the plurality of data feeds associated with the user account by: extracting, from one or more data feeds of the plurality of data feeds, digital communications associated with other user accounts in communication with the user account and extracting, from at least one data feed of the plurality of data feeds, contextual activity data indicating computer processes performed to execute a function indicated by thread data within the at least one data feed.

In certain embodiments, the series of acts 700 includes an act of identifying the subset of thread data corresponding to the topic by identifying one or more of digital communications or contextual activity data corresponding to a common topic shared by the subset of thread data extracted from different data feeds. In these or other embodiments, the series of acts 700 includes an act of generating the aggregate summary comprises utilizing a summary generation model to combine thread data from multiple data feeds associated with the user account.

In one or more embodiments, the series of acts 700 includes an act of generating the aggregate summary by: identifying, from the subset of thread data, a first digital communication from a first data feed and a second digital communication from a second data feed; determining that the first digital communication and the second digital communication comprise at least a threshold amount of overlapping content correspond to the topic; and based on determining that the first digital communication and the second digital communication comprise at least the threshold amount of overlapping content correspond to the topic, deduplicating the aggregate summary by excluding one or more of the first digital communication or the second digital communication from the subset of thread data used to generate the aggregate summary.

In some cases, the series of acts 700 includes an act of identifying the subset of thread data corresponding to the topic by: identifying a digital communication from a messaging application associated with the user account; identifying contextual activity data indicating computer processes performed to execute a function using a non-messaging application; and determining that the digital communication and the contextual activity data corresponding to a shared topic across computer applications.

In certain implementations, the series of acts 700 includes an act of generating the aggregate summary by: identifying a plurality of digital communications corresponding to the topic across multiple data feeds and, based on identifying the plurality of digital communications corresponding to the topic, utilizing a summary generation model to summarize the plurality of digital communications from the multiple data feeds. In some embodiments, the series of acts 700 also or alternatively includes an act of generating the aggregated feed interface by generating, for display on the client device, a user interface that includes a visual graphic indicating a source data feed for generating the aggregate summary.

In one or more embodiments, the series of acts 700 includes an act of extracting the thread data from the plurality of data feeds associated with the user account by: extracting, from a first data feed of the plurality of data feeds, a digital communication associated with the user account; and extracting, from a second data feed of the plurality of data feeds, contextual activity data indicating computer processes performed to execute a function indicated by the second data feed.

In the same or other embodiments, the series of acts 700 includes an act of receiving, via the aggregated feed interface displayed on the client device, a user interaction to send a digital communication corresponding to the aggregate summary. Further, the series of acts 700 can include an act of, in response to the user interaction: determining, based on the subset of thread data, a computer application for transmitting the digital communication; and generating a code segment that, when executed by the computer application, causes the computer application to provide the digital communication to a target user account.

In certain embodiments, the series of acts 700 includes an act of ranking the plurality of aggregate summaries of the thread data extracted from the plurality of data feeds according to relevance to the user account and/or an act of modifying the aggregated feed interface to present the plurality of aggregate summaries based on ranking the plurality of aggregate summaries. The series of acts 700 can also include an act of ranking the plurality of aggregate summaries by utilizing a personalized ranking algorithm specific to the user account, wherein the personalized ranking algorithm weights thread data according to an activity history of the user account across computer applications associated with the plurality of data feeds.

In one or more implementations, the series of acts 700 includes an act of identifying a digital communication from a messaging application associated with the user account. The series of acts 700 can also include acts of identifying contextual activity data indicating computer processes performed to execute a function using a non-messaging application and determining that the digital communication and the contextual activity data corresponding to a shared topic across computer applications.

In some embodiments, the series of acts 700 includes an act of receiving, via the aggregated feed interface displayed on the client device, a user interaction requesting additional information regarding the aggregate summary and/or an act of, in response to the user interaction, generating, to provide for display within the aggregated feed interface, a response comprising the additional information by analyzing the subset of thread data from which the aggregate summary is generated. The series of acts 700 can also include acts of generating an interaction insight indicating reactions from other user accounts to the subset of thread data corresponding to topic of the aggregate summary and modifying the aggregated feed interface to include the interaction insight in relation to the aggregate summary.

The components of the aggregated interface system 102 can include software, hardware, or both. For example, the components of the aggregated interface system 102 can include one or more instructions stored on a computer-readable storage medium and executable by processors of one or more computing devices. When executed by one or more processors, the computer-executable instructions of the aggregated interface system 102 can cause a computing device to perform the methods described herein. Alternatively, the components of the aggregated interface system 102 can comprise hardware, such as a special purpose processing device to perform a certain function or group of functions. Additionally or alternatively, the components of the aggregated interface system 102 can include a combination of computer-executable instructions and hardware.

Furthermore, the components of the aggregated interface system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the aggregated interface system 102 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of exemplary computing device 800 (e.g., the server(s) 104 and/or the client device 108) that may be configured to perform one or more of the processes described above. One will appreciate that server(s) 104 and/or the client device 108 may comprise one or more computing devices such as computing device 800. As shown by FIG. 8, computing device 800 can comprise processor 802, memory 804, storage device 806, I/O interface 808, and communication interface 810, which may be communicatively coupled by way of communication infrastructure 812. While an exemplary computing device 800 is shown in FIG. 8, the components illustrated in FIG. 8 are not intended to be limiting. Additional or alternative components may be used in other implementations. Furthermore, in certain implementations, computing device 800 can include fewer components than those shown in FIG. 8. Components of computing device 800 shown in FIG. 8 will now be described in additional detail.

In particular implementations, processor 802 includes hardware for executing instructions, such as those making up a computer program. As an example and not by way of limitation, to execute instructions, processor 802 may retrieve (or fetch) the instructions from an internal register, an internal cache, memory 804, or storage device 806 and decode and execute them. In particular implementations, processor 802 may include one or more internal caches for data, instructions, or addresses. As an example and not by way of limitation, processor 802 may include one or more instruction caches, one or more data caches, and one or more translation lookaside buffers (TLBs). Instructions in the instruction caches may be copies of instructions in memory 804 or storage device 806.

Memory 804 may be used for storing data, metadata, and programs for execution by the processor(s). Memory 804 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 804 may be internal or distributed memory.

Storage device 806 includes storage for storing data or instructions. As an example and not by way of limitation, storage device 806 can comprise a non-transitory storage medium described above. Storage device 806 may include a hard disk drive (HDD), a floppy disk drive, flash memory, an optical disc, a magneto-optical disc, magnetic tape, or a Universal Serial Bus (USB) drive or a combination of two or more of these. Storage device 806 may include removable or non-removable (or fixed) media, where appropriate. Storage device 806 may be internal or external to computing device 800. In particular implementations, storage device 806 is non-volatile, solid-state memory. In other implementations, Storage device 806 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 808 allows a user to provide input to, receive output from, and otherwise transfer data to and receive data from computing device 800. I/O interface 808 may include a mouse, a keypad or a keyboard, a touch screen, a camera, an optical scanner, network interface, modem, other known I/O devices or a combination of such I/O interfaces. I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 808 is configured to provide graphical data to a display for presentation to a user. The graphical data may be representative of one or more graphical user interfaces and/or any other graphical content as may serve a particular implementation.

Communication interface 810 can include hardware, software, or both. In any event, communication interface 810 can provide one or more interfaces for communication (such as, for example, packet-based communication) between computing device 800 and one or more other computing devices or networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 810 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 810 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 810 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 812 may include hardware, software, or both that couples components of computing device 800 to each other. As an example and not by way of limitation, communication infrastructure 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 9 is a schematic diagram illustrating environment 900 within which one or more implementations of the aggregated interface system 102 can be implemented. For example, the aggregated interface system 102 may be part of a content management system 902 (e.g., the content management system 106). Content management system 902 may generate, store, manage, receive, and send digital content (such as digital content items). For example, content management system 902 may send and receive digital content to and from client devices 906 by way of network 904. In particular, content management system 902 can store and manage a collection of digital content. Content management system 902 can manage the sharing of digital content between computing devices associated with a plurality of users. For instance, content management system 902 can facilitate a user sharing a digital content with another user of content management system 902.

In particular, content management system 902 can manage synchronizing digital content across multiple client devices 906 associated with one or more users. For example, a user may edit digital content using client device 906. The content management system 902 can cause client device 906 to send the edited digital content to content management system 902. Content management system 902 then synchronizes the edited digital content on one or more additional computing devices.

In addition to synchronizing digital content across multiple devices, one or more implementations of content management system 902 can provide an efficient storage option for users that have large collections of digital content. For example, content management system 902 can store a collection of digital content on content management system 902, while the client device 906 only stores reduced-sized versions of the digital content. A user can navigate and browse the reduced-sized versions (e.g., a thumbnail of a digital image) of the digital content on client device 906. In particular, one way in which a user can experience digital content is to browse the reduced-sized versions of the digital content on client device 906.

Another way in which a user can experience digital content is to select a reduced-size version of digital content to request the full- or high-resolution version of digital content from content management system 902. In particular, upon a user selecting a reduced-sized version of digital content, client device 906 sends a request to content management system 902 requesting the digital content associated with the reduced-sized version of the digital content. Content management system 902 can respond to the request by sending the digital content to client device 906. Client device 906, upon receiving the digital content, can then present the digital content to the user. In this way, a user can have access to large collections of digital content while minimizing the amount of resources used on client device 906.

Client device 906 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 906 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 904.

Network 904 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 906 may access content management system 902.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
generating, for display on a client device associated with a user account, an aggregated feed interface depicting a plurality of aggregate summaries of thread data extracted from a plurality of data feeds associated with the user account;
identifying, from among the plurality of data feeds, a subset of thread data corresponding to a topic;
generating an aggregate summary corresponding to the subset of thread data; and
providing the aggregate summary for display within the aggregated feed interface on the client device.

2. The method of claim 1, wherein generating the aggregated feed interface comprises generating, for display on the client device, a user interface that includes a visual indication of a data feed used as a source of the subset of thread data for generating the aggregate summary.

3. The method of claim 1, further comprising extracting the thread data from the plurality of data feeds associated with the user account by:
extracting, from one or more data feeds of the plurality of data feeds, digital communications associated with other user accounts in communication with the user account; and
extracting, from at least one data feed of the plurality of data feeds, contextual activity data indicating computer processes performed to execute a function indicated by thread data within the at least one data feed.

4. The method of claim 1, wherein identifying the subset of thread data corresponding to the topic comprises identifying one or more of digital communications or contextual activity data corresponding to a common topic shared by the subset of thread data extracted from different data feeds.

5. The method of claim 1, wherein generating the aggregate summary comprises utilizing a summary generation model to combine thread data from multiple data feeds associated with the user account.

6. The method of claim 1, wherein generating the aggregate summary comprises:
identifying, from the subset of thread data, a first digital communication from a first data feed and a second digital communication from a second data feed;
determining that the first digital communication and the second digital communication comprise at least a threshold amount of overlapping content correspond to the topic; and
based on determining that the first digital communication and the second digital communication comprise at least the threshold amount of overlapping content correspond to the topic, deduplicating the aggregate summary by excluding one or more of the first digital communication or the second digital communication from the subset of thread data used to generate the aggregate summary.

7. The method of claim 1, wherein identifying the subset of thread data corresponding to the topic comprises:
identifying a digital communication from a messaging application associated with the user account;
identifying contextual activity data indicating computer processes performed to execute a function using a non-messaging application; and
determining that the digital communication and the contextual activity data corresponding to a shared topic across computer applications.

8. A system comprising:
at least one processor; and
a non-transitory computer readable medium comprising instructions that, when executed by the at least one processor, cause the system to:
generate, for display on a client device associated with a user account, an aggregated feed interface depicting a plurality of aggregate summaries of thread data extracted from a plurality of data feeds associated with the user account;
identify, from among the plurality of data feeds, a subset of thread data corresponding to a topic;
generate, from the subset of thread data corresponding to the topic, an aggregate summary specific to the topic; and
provide the aggregate summary for display within the aggregated feed interface on the client device.

9. The system of claim 8, further comprising instructions that, when executed by the at least one processor, cause the system to generate the aggregate summary by:
identifying a plurality of digital communications corresponding to the topic across multiple data feeds; and
based on identifying the plurality of digital communications corresponding to the topic, utilizing a summary generation model to summarize the plurality of digital communications from the multiple data feeds.

10. The system of claim 8, further comprising instructions that, when executed by the at least one processor, cause the system to generate the aggregated feed interface by generating, for display on the client device, a user interface that includes a visual graphic indicating a source data feed for generating the aggregate summary.

11. The system of claim 10, further comprising instructions that, when executed by the at least one processor, cause the system to extract the thread data from the plurality of data feeds associated with the user account by:
extracting, from a first data feed of the plurality of data feeds, a digital communication associated with the user account; and
extracting, from a second data feed of the plurality of data feeds, contextual activity data indicating computer processes performed to execute a function indicated by the second data feed.

12. The system of claim 8, further comprising instructions that, when executed by the at least one processor, cause the system to:
receive, via the aggregated feed interface displayed on the client device, a user interaction to send a digital communication corresponding to the aggregate summary; and
in response to the user interaction:
determining, based on the subset of thread data, a computer application for transmitting the digital communication; and
generating a code segment that, when executed by the computer application, causes the computer application to provide the digital communication to a target user account.

13. The system of claim 8, further comprising instructions that, when executed by the at least one processor, cause the system to:
rank the plurality of aggregate summaries of the thread data extracted from the plurality of data feeds according to relevance to the user account; and
modify the aggregated feed interface to present the plurality of aggregate summaries based on ranking the plurality of aggregate summaries.

14. The system of claim 13, further comprising instructions that, when executed by the at least one processor, cause the system to rank the plurality of aggregate summaries by utilizing a personalized ranking algorithm specific to the user account, wherein the personalized ranking algorithm weights thread data according to an activity history of the user account across computer applications associated with the plurality of data feeds.

15. A non-transitory computer readable medium comprising instructions that, when executed by at least one processor, cause the at least one processor to:
generate, for display on a client device associated with a user account, an aggregated feed interface depicting a plurality of aggregate summaries of thread data extracted from a plurality of data feeds associated with the user account;
identify, from among the plurality of data feeds, a subset of thread data corresponding to a topic;
generate, from the subset of thread data corresponding to the topic, an aggregate summary; and
provide the aggregate summary for display within the aggregated feed interface on the client device together with the plurality of aggregate summaries.

16. The non-transitory computer readable medium of claim 15, further comprising instructions that, when executed by the at least one processor, cause the at least one processor to generate the aggregated feed interface by generating, for display on the client device, a user interface that includes a visual indication of a data feed used as a source of the subset of thread data for generating the aggregate summary.

17. The non-transitory computer readable medium of claim 15, further comprising instructions that, when executed by the at least one processor, cause the at least one processor to generate the aggregate summary by utilizing a summary generation model to combine thread data from multiple data feeds associated with the user account.

18. The non-transitory computer readable medium of claim 17, further comprising instructions that, when executed by the at least one processor, cause the at least one processor to:
identify a digital communication from a messaging application associated with the user account;
identify contextual activity data indicating computer processes performed to execute a function using a non-messaging application; and
determine that the digital communication and the contextual activity data corresponding to a shared topic across computer applications.

19. The non-transitory computer readable medium of claim 15, further comprising instructions that, when executed by the at least one processor, cause the at least one processor to:
receive, via the aggregated feed interface displayed on the client device, a user interaction requesting additional information regarding the aggregate summary; and
in response to the user interaction, generating, to provide for display within the aggregated feed interface, a response comprising the additional information by analyzing the subset of thread data from which the aggregate summary is generated.

20. The non-transitory computer readable medium of claim 15, further comprising instructions that, when executed by the at least one processor, cause the at least one processor to:
generate an interaction insight indicating reactions from other user accounts to the subset of thread data corresponding to topic of the aggregate summary; and
modify the aggregated feed interface to include the interaction insight in relation to the aggregate summary.
